(19) United States
(12) Patent Application Publication
(10) Pub. No.: US 2026/0084158 A1
(43) Pub. Date: Mar. 26, 2026

(54) DEVICE FOR HOLDING SAMPLE VESSELS AND A KIT COMPRISING THE DEVICE

(71) Applicant: Ritter GmbH, Schwabmuenchen (DE)

(72) Inventor: Frank FINIS, Augsburg (DE)

(21) Appl. No.: 19/327,446

(22) Filed: Sep. 12, 2025

(30) Foreign Application Priority Data
Sep. 24, 2024 (DE) 10 2024 127 487.5

(51) Int. Cl. B01L 9/00

(52) U.S. Cl. CPC B01L 9/543; B01L 2200/023; B01L 2200/028

(57) ABSTRACT

An embodiment of a container 1 for holding sample vessels (wells) and/or pipette tips has a housing component 2 and a holding component 3 with a first area 30 with a plurality (72) of first receiving positions 30.1, 30.2, 30.3, . . . 30.72 for receiving a first type of sample vessels and/or pipette tips, and a second area 31 with a plurality (24) of second receiving positions 31.1, 31.2, 31.3, . . . 31.24 for receiving a second type of sample vessels and/or pipette tips.

### TECHNICAL FIELD

This application relates to a device for holding at least one of sample vessels and pipette tips, comprising a holding component with multiple receiving positions and locations, respectively.

### PRIOR ART

Manual and automatic pipetting devices or pipetting machines, i.e. liquid handling systems, for handling pipette tips are used in a variety of analytical applications in which liquids are handled, for example transported, taken up or dispensed, for example in laboratories. Disposable pipette tips are used in these devices or machines. Disposable pipette tips are usually conical in shape from top to bottom and may have specially shaped sections for gripping and sealing the pipette tips against a coupling device of the pipetting machine or automatic pipetting device that engages with the interior of the pipette tip. Pipetting machines or automatic pipetting devices usually engage with the top of the pipette tip. In many applications, the coupling device is inserted into the upper interior volume of the pipette tip. Pipetting machines or automatic pipetting devices exert negative pressure to aspirate liquids into the pipette tip and generate positive pressure to dispense liquids from the pipette tip.

In addition, so-called microtiter plates are used in laboratories to examine the biological properties of samples, e.g. by means of light absorption measurement or PCR (polymerase chain reaction) tests. Microtiter plates are used in various microbiological work processes. Typical fields of application are cell culture or the screening of bioreactions. Microtiter plates have a large number of sample wells, making them suitable for cultivation and for tests with large numbers of samples and high throughput. The sample wells may be filled and emptied at high throughput using automatic devices, e.g. automatic pipetting devices mentioned above.

Microtiter plates are usually made of plastic, e.g. polypropylene, polystyrene, polyvinyl chloride, polyamide, etc. The sample wells may be arranged in rows and columns in a tray in a predetermined number. The number of wells on a tray of a microtiter plate is arbitrary and may range from a few single (e.g. 2×3) to several thousand (e.g. 48×72) sample well positions. The wells may be made of the same material as the tray or of a different material. Pipette tips and sample vessels are usually made of a mouldable plastic, such as polypropylene (PP), polyethylene, polyphenylene sulphide (PPS), polycarbonate (PC), or similar, using an injection moulding process, as plastics offer a good combination of properties such as chemical resistance, low surface adsorption, transparency (if required) and cost-efficient production. Pipette tips are also manufactured in various sizes to enable accurate and reproducible handling of liquids in a wide volume range (nanolitres to millilitres).

In many cases, pipette tips and sample vessels are used in large quantities for automated processing of a large number of samples and for adding various reagents to samples.

However, there are special applications where pipette tips made of materials such as ceramic or metal are used, for example, where there are high chemical requirements, e.g. corrosion resistance or temperature resistance. In addition, ceramic pipette tips may be manufactured with smaller dimensions, in particular smaller outlet openings. However, ceramic or metal pipette tips are much more complex in terms of manufacturing and material usage.

In order to enable easy handling of high quantities of pipette tips and sample vessels, respectively, pipette tips and sample vessels are often supplied in a pipette tip tray with openings on the top in which the pipette tips and vessels, respectively, are arranged and held in an array. The tray may in turn be placed on or mounted on a carrier. The tray and the carrier form a pipette tip holder/vessel holder, which may be equipped with a lid to cover the pipette tips and sample vessels, respectively.

Furthermore, holders for pipette tips and/or sample vessels (microtiter plates) are designed so that a large number of samples may be analyzed in parallel in analysis laboratories, with each holder being used for specific process steps.

### OBJECT OF THE INVENTION

Based on this, an object of the present invention is to provide devices for holding pipette tips and/or sample vessels (microtiter plates), trays for pipette tips and/or sample vessels (microtiter plates), and assemblies for holding pipette tips and/or sample vessels (microtiter plates) that enable specific processing of a sample in an automatic analysis device.

### SUMMARY OF THE INVENTION

This object is solved by a device for holding pipette tips and/or sample vessels according to claim 1. The dependent claims refer to features of preferred embodiments of the invention.

A device according to the invention for holding sample vessels and/or pipette tips comprises: a holding component with at least one first receiving position and location, respectively, and at least one second receiving position and location, respectively, for holding and receiving, respectively, at least one sample vessel and/or one pipette tip, wherein the at least two receiving positions and locations, respectively, have different configuration.

This means that the receiving positions and locations, respectively, are suitable for different types and sizes of pipette tips and sample vessels, and for simultaneously receiving pipette tips and sample vessels in different locations/positions. The receiving locations/positions may be designed so that all pipette tips and sample vessels required for a specific analysis program may be provided in a holding device and a tray, respectively. This enables individual processing of a sample in an analysis device. The holding device is thus a multifunctional microtiter plate or a multifunctional holder or receiver, or a multifunctional tray for pipette tips and sample vessels.

In particular, the first receiving position/location and the second receiving position/location are designed to receive different vessels and/or different types of pipette tips, and/or at least one receiving location is designed to receive a vessel and at least one receiving location is designed to receive a pipette tip.

A number of analysis methods require the transfer of liquids between vessels of different volumes. This is taken into account by a configuration according to the invention, in which a certain proportion x1 of the total surface of the holder is provided with receiving locations/positions of type/size X1, a further proportion x2 of the total surface of the holder is provided with receiving locations/positions of type/size X2, etc., with x1+x2+x3+ . . . +xn=100%, where n is the total number of types of receiving locations/positions in a device.

By selecting a suitable arrangement of receiving locations/positions of different types or sizes, programmed analysis procedures in an analysis robot, for example, may be optimized in terms of time and reliability of the procedure by shortening the distances involved in handling pipette tips and sample vessels.

The holding component may have a plate-like receiving surface, and the receiving locations/positions may be formed as openings in the holding component. The openings may be open at the bottom or closed at the bottom (blind holes). They may have various cross-sectional geometries.

For example, the opening of the first receiving position/location may have a different diameter than the opening of the second receiving location/position. Although the term ‘diameter’ normally refers to circular openings, in the context of this invention, the term should be understood to mean an average diameter if the opening has a different shape (e.g., square, elliptical, etc.).

The first receiving location/position and the second receiving location/position may each have an edge area that delimits the respective opening, wherein the edge area of the first receiving location/position and the edge area of the second receiving location/position are designed differently. For example, the opening may be delimited by a sleeve with a specific axial length. The sleeve-like edge area may be provided with different axial lengths of the sleeve and/or with different geometries of the sleeve.

All receiving locations/positions may have a support edge that delimits a receiving opening and is provided for supporting a corresponding projection or web that is designed on the outside of a vessel or pipette tip compatible with a specific type/size of receiving location/position.

The holding component may comprise an arrangement of at least one first area with first receiving locations and a second area with at least one second receiving location. Several areas may be provided for different types of sample vessels or pipette tips, each with the same receiving locations in each area. Examples of such arrangements are provided in the following description of preferred embodiments.

The areas may form self-contained modular areas. This means that at least one of the areas physically or virtually forms a module with a specific type of receiving location(s) or may be regarded as such. A modular design may mean, in particular, that the modules form units with a specific type of receiving locations/positions and/or are manufactured in different manufacturing processes and/or from different materials and/or with different properties, and/or that they may be manufactured as separate components and assembled and connected with other modules to form a container or a tray.

The holding component may essentially consist of areas arranged adjacent to one another, or the areas may be designed as individual modules.

The modularly designed areas may be joinable (e.g. pluggable) and/or attachable to one another.

For this purpose the modularly designed areas may have guide and/or fastening elements.

In particular, the device may be designed as a container comprising a housing component and the holding component arranged thereon. The components may be designed as a single piece/integral or in multiple parts. The container may optionally have a lid.

Alternatively, the device may be designed as a tray.

The object of the invention is also solved by a combination of a tray as described above and a housing component (also referred to as a ‘rack’ or ‘carrier’), wherein the tray is arranged on the housing component. The housing component may be a frame with a window arranged in the upper region of the frame for inserting the tray, and a standing surface arranged in the lower region of the frame. In this case, the rack supports the tray.

With the help of the devices or combinations according to the invention, a kit may be provided which comprises the device described above and sample vessels and/or pipette tips for use in a predetermined analysis program. Reagents required in the analysis program may already be present in the vessels. By using a special or specially programmed automatic analysis device into which the devices according to the invention may be inserted, even persons who have no knowledge of handling samples for analysis may carry out analytical procedures.

### BRIEF DESCRIPTION OF THE FIGURES

Further features and advantages of the invention will become apparent from the following description with reference to the figures. The figures show:

FIG. 1A a perspective view of a first embodiment of a container according to the present invention for holding sample vessels and/or pipette tips;

FIG. 1B a top view of the first embodiment;

FIG. 2A a perspective view of a second embodiment of a container according to the present invention for holding sample vessels and/or pipette tips;

FIG. 2B a top view of the second embodiment;

FIG. 3A a perspective view of a third embodiment of a container according to the present invention for holding sample vessels and/or pipette tips;

FIG. 3B a top view of the third embodiment;

FIG. 4A a perspective view of a fourth embodiment of a container according to the present invention for holding sample vessels and/or pipette tips;

FIG. 4B a top view of the fourth embodiment;

FIG. 5A a perspective view of a fifth embodiment of a container according to the present invention for holding sample vessels and/or pipette tips;

FIG. 5B a top view of the fifth embodiment;

FIG. 6A a perspective view of a sixth embodiment of a container according to the present invention for holding sample vessels and/or pipette tips;

FIG. 6B a top view of the sixth embodiment;

FIG. 7A a perspective view of a seventh embodiment of a container according to the present invention for holding sample vessels and/or pipette tips;

FIG. 7B a top view of the seventh embodiment;

FIG. 8A a perspective view of an eighth embodiment of a container according to the present invention for holding sample vessels and/or pipette tips;

FIG. 8B a top view of the eighth embodiment;

FIG. 9A a perspective view of a ninth embodiment of a container according to the present invention for holding sample vessels and/or pipette tips;

FIG. 9B a top view of the ninth embodiment;

FIG. 10A a perspective view of a tenth embodiment of a container according to the present invention for holding sample vessels and/or pipette tips;

FIG. 10B a top view of the tenth embodiment;

FIG. 11A a perspective view of an eleventh embodiment of a container according to the present invention for holding sample vessels and/or pipette tips;

FIG. 11B a top view of the eleventh embodiment;

FIG. 12A a perspective view of a twelfth embodiment of a container according to the present invention for holding sample vessels and/or pipette tips;

FIG. 12B a top view of the twelfth embodiment;

FIG. 13A a perspective view of a thirteenth embodiment of a container according to the present invention for holding sample vessels and/or pipette tips;

FIG. 13B a top view of the thirteenth embodiment;

FIG. 13C a bottom view of the thirteenth embodiment;

FIG. 14A a perspective view of a fourteenth embodiment of a container according to the present invention for holding sample vessels and/or pipette tips;

FIG. 14B a top view of the fourteenth embodiment;

FIG. 15A a perspective view of a fifteenth embodiment of a container according to the present invention for holding sample vessels and/or pipette tips;

FIG. 15B a top view of the fifteenth embodiment;

FIG. 16A a perspective view of a first embodiment of a tray according to the present invention;

FIG. 16B a top view of the first embodiment of a tray;

FIG. 17A a perspective view of a second embodiment of a tray according to the present invention;

FIG. 17B a top view of the second embodiment of the tray;

FIG. 18A a perspective view of a third embodiment of a tray according to the present invention;

FIG. 18B a top view of the third embodiment of a tray;

FIG. 19A a perspective view of a first embodiment of an assembly according to the invention;

FIG. 19B a top view of the first embodiment of an assembly;

FIG. 20A a perspective view of a second embodiment of an assembly according to the invention;

FIG. 20B a top view of the second embodiment of an assembly;

FIG. 21A a perspective view of a third embodiment of an assembly according to the invention;

FIG. 21B a top view of the third embodiment of an assembly;

FIG. 22A a perspective view of a tray with guide elements according to the invention;

FIG. 22B a top view of the tray with guide elements of FIG. 22A;

FIG. 22C a detail of FIG. 22A.

### DESCRIPTION OF PREFERRED EMBODIMENTS OF THE INVENTION

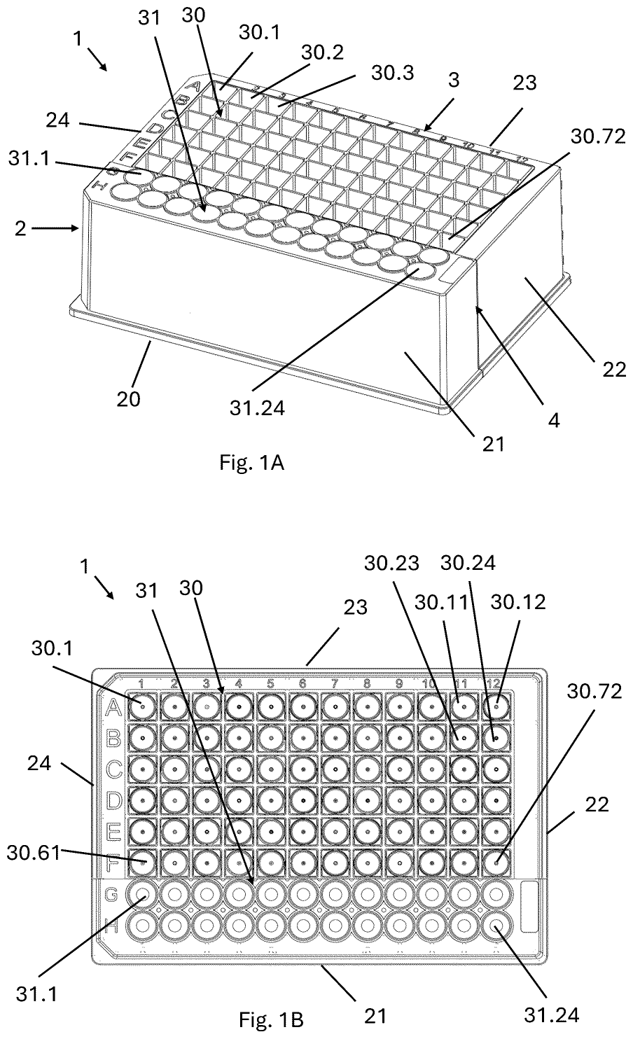

FIGS. 1A-22C show examples of embodiments of the invention relating to combined elements such as microtiter plates with sample wells, pipette tip trays and containers with pipette tips, and kits for multifunctional applications.

### Microtiter Plates

Microtiter plates are usually made of plastic, e.g. polypropylene (PP), polyethylene (PE), polyethylene terephthalate (PET), polycarbonates (PC), polyvinyl chloride (PVC), polyethylene fluorethylene (PEFE), polystyrene (PS), polysiloxane, polyurethane, cellulose, polyamide (PA), polyphenylene sulphide (PPS), etc. The sample wells may be arranged in rows and columns in a tray in a predetermined number. The number of vessels on a tray of a microtiter plate is arbitrary and may range from a few single (e.g. 2×3) to several thousand (e.g. 48×72) receiving locations and positions, respectively, for sample vessels. The vessels may be made of the same material as the tray or of a different material, depending on the application. Vessels may be provided individually. Alternatively, several vessels may be connected, e.g. as flat elements, strips, etc.

### Pipette Tip Holders

A pipette tip holder (e.g. container or tray) is an arrangement of components that provides pipette tips for use in an application. Pipette tip holders often have at least one carrier (‘rack’), a lid and a tray in which the pipette tips are mounted, with the pipette tips being arranged in an array in a substantially immovable manner.

The tray is located on the top of the carrier and has openings for receiving pipette tips. The tray may be integrated directly in the carrier, e.g. moulded onto it, or the tray may form a separate unit that is attached to the carrier, e.g. by a snap or latch connection, by gluing, welding, etc.

The pipette tips used are inserted into the openings of the tray in such a way that they may be removed. They usually rest on the edge of one of the tray openings. They may protrude upwards beyond the edge of the tray, while the lower part of the pipette tips is usually located below the lower surface of the tray. The tray may have a suitable number of openings, e.g. 8×n (n=1, 2, . . . , 432) openings.

Each component of the pipette tip holder may be made of a suitable material, e.g. one or more plastic/resin materials, e.g. polypropylene (PP), polyethylene (PE), polyethylene terephthalate (PET), polycarbonates (PC), polyvinyl chloride (PVC), polyethylene fluorethylene (PEFE), polystyrene (PS), polysiloxanes, polyurethane, cellulose, polyamide (PA), polyphenylene sulphide (PPS), etc.

The components of the pipette tip holder or tray may be moulded individually and then assembled. Manufacturing processes for the components include thermoforming, extrusion or moulding (plastic injection moulding).

The components of the pipette tip holder are assembled or joined together. In another embodiment, they may be manufactured using a 2-component injection moulding process. The lid may be fitted precisely onto the carrier, e.g. by engaging in a groove or recess formed in the carrier. The lid may be loosely or movably connected to the carrier, e.g. via plug connections, or pivotable via a hinge.

### Pipette Tips and Sample Vessels

Pipette tips and sample vessels are usually made from mouldable plastic/resin, such as polypropylene (PP), polyethylene, polyphenylene sulphide (PPS) or similar, using an injection moulding process, as plastics offer a good combination of properties such as chemical resistance, low surface adsorption, transparency (if required) and cost-efficient production. Besides, pipette tips are manufactured in various sizes in order to enable accurate and reproducible handling of liquids in a wide volume range (nanolitres to millilitres).

The pipette tips and sample vessels inserted into the tray may essentially be fixed horizontally and vertically, e.g. by the shape of the tray openings. The edges of the openings may be conical. Fixation may be achieved by form fit, force fit and/or friction fit. In another embodiment, material-locking connection may be possible, particularly for sample vessels.

Pipette tips and sample vessels with different geometries are known. The geometry of pipette tips and sample vessels is adapted so that, in conjunction with a coupling device of an analysis device or a pipetting device or automatic pipetting device, they are suitable for receiving and dispensing liquids. Pipette tips and sample vessels are usually available in different sizes, e.g. 10 microlitres, 50 microlitres, 100 microlitres, 250 microlitres, 1000 microlitres, 2500 microlitres, etc.

The outer contour and inner contour of pipette tips are adapted for use in combination with or interaction with a specific liquid handling system, e.g. a pipetting machine or an automatic pipetting device. The outer contour of pipette tips usually tapers from the upper (proximal) section (having a first upper opening) to the lower (distal) section, which has a second small lower opening. The outer contour must be suitable for attachment of the pipette tip to a coupling device.

The inner wall of the pipette tip delimits a substantially tapered inner volume, wherein steps, enlargements of the inner diameter or projections extending inwards may be provided in particular sections of the inner contour. The taper may be continuous and/or stepped, steady and/or unsteady, either overall or in sections. It must be ensured that a fluid taken up has suitable fluid flow properties. In most embodiments, a pipette tip inner wall comprises at least two taper angles.

The outer and inner walls, respectively, have a substantially tapered, for example stepped or conical, contour. The taper angle(s) is/are approximately between 0° and 30° relative to the central longitudinal axis, e.g. 0°, 5°, 10°, 15°, 20°, 25°, 30°. In some embodiments, the contour is stepped or cylindrical. Steps, abutments, stops or grooves may be provided.

A typical conventional pipette tip has a total length of approximately 2.5 cm to 10 cm. The distal dispensing opening typically has an inner diameter of between 0.2 mm and 0.8 mm, e.g. 0.2 mm, 0.3 mm, 0.4 mm, 0.5 mm, 0.6 mm, 0.7 mm, 0.8 mm. The wall thickness in this (distal) section is approximately 0.1 mm and 0.5 mm, e.g. 0.1 mm, 0.2 mm, 0.3 mm, 0.4 mm, 0.5 mm.

In the proximal section, the inner diameter is approximately 2.5 mm to 10 mm, e.g. 2.5 mm, 5 mm, 7.5 mm, 10 mm, with a typical wall thickness in the proximal section between 0.5 mm and 1.5 mm, e.g. 0.5 mm, 0.75 mm, 1.0 mm, 1.25 mm, 1.5 mm.

The wall thickness may be constant along a section or vary continuously and/or in steps.

A proximal or distal section of a pipette tip may contain a filter, an insert or other auxiliary material.

In one embodiment, (disposable) pipette tips comprise: a wall defining an interior space; a first, upper (proximate) opening and a second, lower (distal) opening, which are arranged at the upper end and at the lower end of the interior space, respectively; a first section adjoining the upper opening; a second section adjoining the first section; a third section adjoining the second section; a fourth section adjoining the third section; and a fifth section adjoining the fourth section and extending into the lower opening; a first transition area between the first section and the second section; a second transition area between the second section and the third section; a third transition area between the third section and the fourth section; wherein the sections and the transition areas may have an inner contour or inner geometry or a configuration in accordance with the following description of the invention.

The term ‘above’ refers to an area of the wall or interior of the pipette tip closer to the first, upper (proximal) opening, into which a retaining/sealing pin of the pipetting device may penetrate as intended in order to hold and seal the pipette tip. The term ‘below’ refers to an area of the wall or interior of the pipette tip closer to the second, lower (distal) opening through which the pipetted fluid is intended to be aspired or dispensed during operation. The upper opening is usually larger than the lower opening.

The direction ‘from top to bottom’ means the axial direction from the upper (proximal) opening to the lower (distal) opening. ‘Axial’ is a direction perpendicular to a plane defined by the upper and/or lower edge of the pipette tip. ‘Radial’ means a direction parallel to the plane defined by the upper and/or lower edge of the pipette tip, i.e. perpendicular to ‘axial’. A taper or reduction in cross-section from top to bottom means that the cross-section in a position closer to the first opening is larger than the cross-section in a position closer to the second opening. A widening or increase in cross-sectional area occurs when the cross-sectional area at a position closer to the first opening is smaller than the cross-sectional area at a position closer to the second opening. This applies to both the sections of the pipette tip and the transition areas.

Sections of the wall or the interior of the pipette tip have an axial and, optionally, a radial extension. Transition areas of the wall or the interior of the pipette tip may have an axial extension and/or a radial extension. However, they may also be designed without axial/radial extension as a continuous transition, e.g. as an edge.

An undercut or back taper is present in the case of a widening or cross-sectional enlargement (when viewing the interior through the upper opening in the direction of the lower opening), as described above. An undercut may be a continuous transition with or without axial extension. A pipette tip according to the invention comprises: a wall defining an interior space; a first upper opening and a second lower opening arranged at the upper end and the lower end of the interior space, respectively; a first section adjoining the upper opening; a second section adjoining the first section; a third section adjoining the second section; a fourth section adjoining the third section; and a fifth section adjoining the fourth section and opening into the lower opening; a first transition region between the first section and the second section; a second transition region between the second section and the third section; a third transition area between the third section and the fourth section); wherein the diameter of the upper opening is greater than the diameter of the lower opening; wherein the interior space has at least sectional cylindrical and/or tapered sections and/or transition areas extending from top to bottom.

Optionally, the interior space may have at least one section and/or one transition area that widens from top to bottom so that an undercut is formed.

FIGS. 1A and 1B show a first embodiment of a container 1 according to the present invention for holding sample vessels (wells) and/or pipette tips.

The container 1 has a housing component 2 with four approximately vertically aligned wall elements 21, 22, 23, 24 and a base surface 20. In addition, the container 1 has a holding component 3 with a first area 30 with a plurality (72) of first receiving positions and locations, respectively, 30.1, 30.2, 30.3, . . . 30.72 (corresponding to the designations A1-F12) for a first type of sample vessels and/or pipette tips, and a second area 31 with a plurality (24) of second receiving positions and locations, respectively, 31.1, 31.2, 31.3, . . . 31.24 (corresponding to designations G1-H12) for a second type of sample vessels and/or pipette tips.

For example, the first receiving locations 30.1, . . . , 30.72 may be suitable for receiving vessels corresponding to a microtiter plate. The vessels may be individual and inserted into different first receiving positions and locations, respectively, or they may be segmented, e.g. as strips with six vessels that may be inserted into first receiving locations 30.1, 30.13, 30.25, 30.37, 30.49, 30.61, or the vessels may be connected in two dimensions as a flat element (array), e.g. as an element with 2×2=4 vessels that are connected, whereby the element may be inserted, for example, into the first receiving locations 30.11, 30.12, 30.23 and 30.24. The holding component 3 and the vessels may be made of different materials. The vessels may be of the same or different shapes and/or sizes and/or made of the same or different materials.

For example, the second receiving locations 31.1, . . . , 31.24 may be suitable for receiving pipette tips. The pipette tips are usually individual and may be inserted into different second receiving locations. The holding component 3 and the pipette tips may be made of different materials.

The pipette tips may be manufactured with the same or different shapes and/or sizes and/or from the same or different materials.

The container 1 may be equipped with vessels/wells and/or pipette tips that are required in a specific analysis program, which is executed, for example, by an analysis robot. The vessels are placed at specific receiving locations in the first area 30 and, if necessary, filled with reagents required in the analysis program. The pipette tips are placed at specific receiving locations of the second area. They are used to transport liquids through the analysis robot as part of the analysis program. This allows liquids to be transported between the vessels.

The container 1 is multifunctional, as it provides a microtiter plate in the first area 30 and a tray for pipette tips in the second area 31.

The container 1 according to the invention may integrally be formed with a tray that has or combines different receptacle areas 30, 31. On the other hand, container 1 may be modular in design, i.e. it may be assembled/composed of several parts. A first module may thus comprise the first receptacle area 30, and a second module may form the second receptacle area 31. The modules are joined together along an interruption plane 4. This means that different modules may be combined, depending on the intended use.

Some of the receiving locations and positions, respectively, are intended for receiving vessels, while others are intended for receiving pipette tips. Depending on the analysis program, the vessels and pipette tips, respectively, may have different geometries, different volumes, different materials, etc., and may be filled with specific samples and reagents required for the analysis program. Such a kit consisting of a container/tray/sample vessels/pipette tips may then be loaded with a sample to be analyzed (e.g. blood) and inserted into a small analysis device. An analysis program may then be started.

In the following embodiments, corresponding features are designated with the same reference numerals as in FIGS. 1A and 1B.

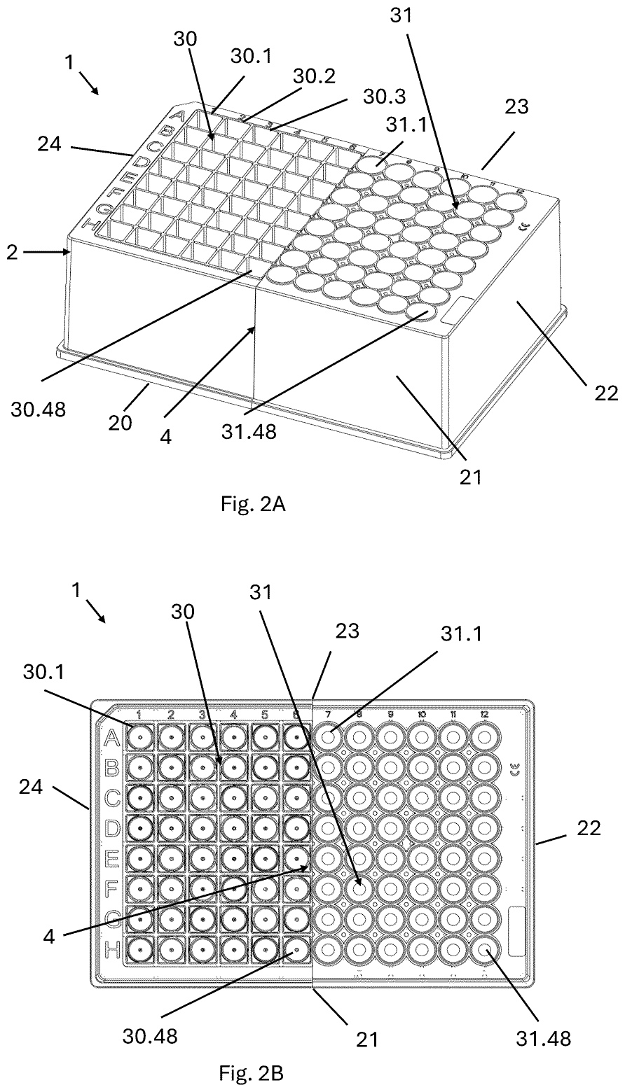

FIGS. 2A and 2B show a second embodiment of a container 1 according to the present invention for holding sample vessels (wells) and/or pipette tips.

The container 1 has a housing component 2 with four approximately vertically aligned wall elements 21, 22, 23, 24 and a base 20. In addition, the container 1 has a holding component 3 with a first area 30 having a plurality (48) of first receiving positions 30.1, 30.2, 30.3, . . . 30.48 (corresponding to the designations A1-H6) for a first type of sample containers and/or pipette tips, and a second area 31 with a plurality (48) of second receiving positions 31.1, 31.2, 31.3, . . . 31.48 (corresponding to the designations G1-H12) for a second type of sample vessels and/or pipette tips.

For example, the first receiving positions 30.1, . . . , 30.48 may be suitable for receiving vessels/wells corresponding to a microtiter plate. The vessels may be of the same or different shapes and/or sizes and/or made of the same or different materials.

For example, the second receiving positions 31.1, . . . , 31.48 may be suitable for holding pipette tips. The pipette tips may be of the same or different shapes and/or sizes and/or made of the same or different materials.

As described in the first embodiment, the container 1 may be equipped with vessels and/or pipette tips that are required in a specific analysis program, for example in an analysis robot.

In a kit including the container 1 according to the invention, trays for different tips (sizes/manufacturers) may be combined. A first tray may be arranged in the first receiving area 30, a second tray may be arranged in the second receiving area 31. Electrically conductive tips may be combined with electrically non-conductive tips in a tray. Pipette tips of a first size may be arranged in one tray, pipette tips of a second size in another tray, etc., whereby the trays may be arranged in a container 1.

Depending on their intended use, conventional microtiter plates have a large number of wells, e.g. 96 wells, 384 wells, etc., of the same size (e.g. 2 ml, 0.2 ml, etc.). If different well sizes are required for a particular test, the different wells may be arranged in the different areas 30, 31. This means that areas 30 and 31 are each adapted to hold wells (individually, as strips or as an array) of one type. This allows wells of different sizes (as well as pipette tips) to be combined in one container 1.

In a modular design, the modules constituting areas 30 and 31 may be connected to each other along a separating, interrupting or connecting plane 4. Possible connection options include clipping, gluing, etc. The modules may be made of different materials. For example, one module may be transparent to allow visual inspection/analysis, while the other module may not be transparent.

In the second embodiment, for example, 48 receptacles for pipette tips and a further 48 receptacles for analysis vessels (microtiter plate) may be designated.

The kit may be processed with a programmed liquid handling system without the user requiring expertise or experience in analytics.

The following embodiments are variants of the first and second embodiments, whereby the features of the first and second embodiments are transferable to the following variants.

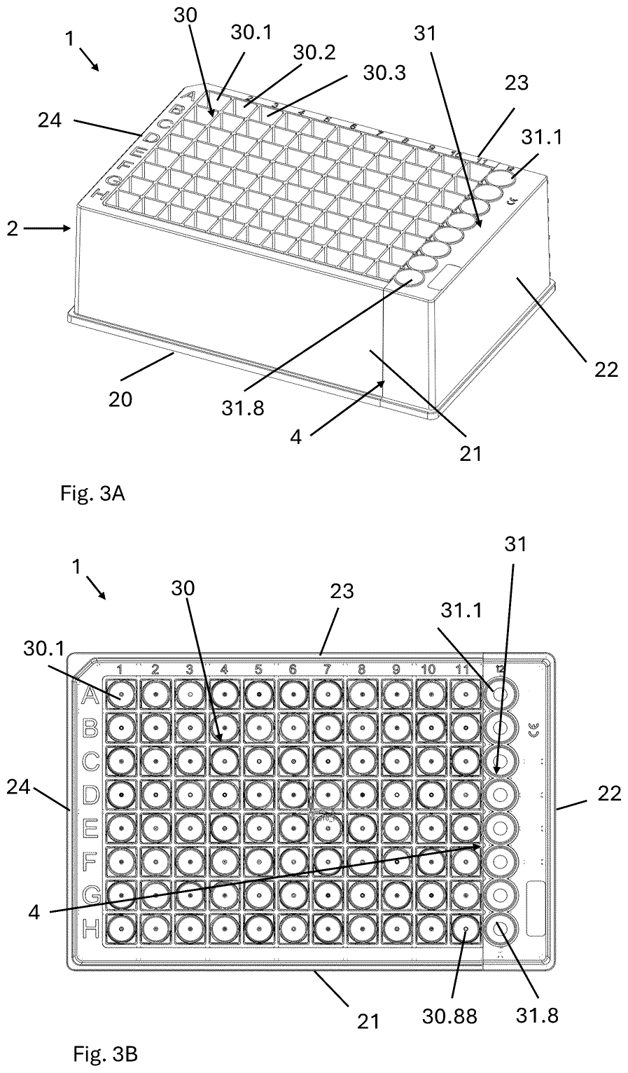

FIGS. 3A and 3B show a third embodiment of a container 1 according to the present invention for holding sample vessels (wells) and/or pipette tips. In contrast to the previous embodiments, the container 1 has eight (8) receiving positions of a first type in a first area 30 and eight (8) receiving positions of a second type in a second area 31.

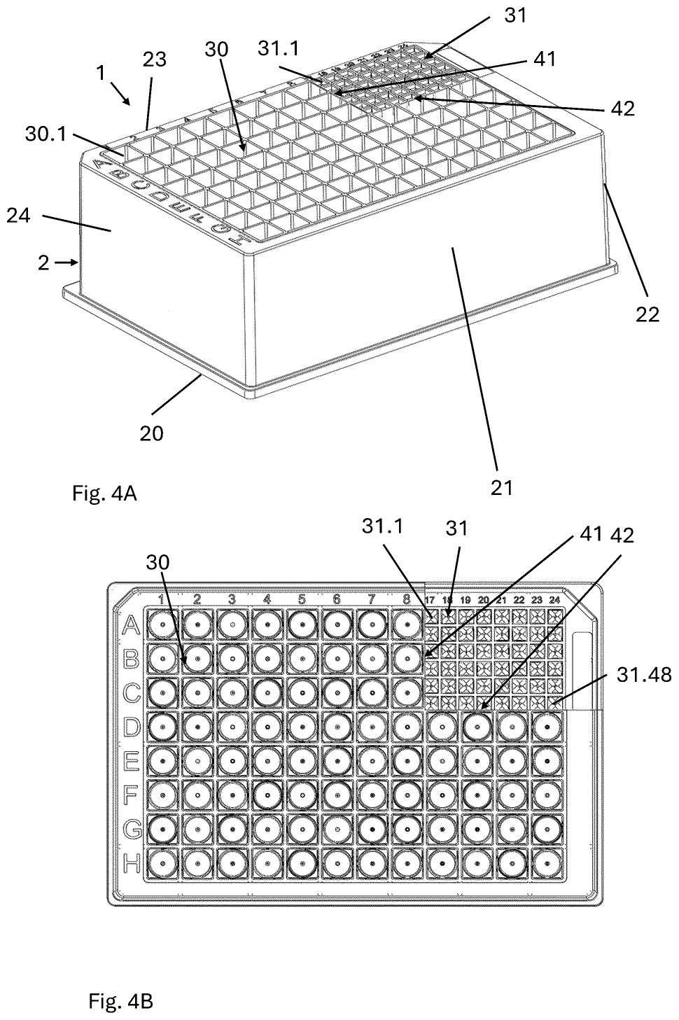

FIGS. 4A and 4B show a fourth embodiment of a container 1 according to the present invention for holding sample vessels (wells) and/or pipette tips. In contrast to the previous embodiments, the container 1 has a second area 31, which is rectangular in shape and occupies an area of a corner of the container 1 (with parts of the walls 22 and 23). Accordingly, there are two separating planes or separating seams 41, 42 aligned perpendicular to each other, which are arranged between the first area 30 and the second area 31.

In the second area 31, smaller receiving positions 31.1, . . . 31.48 are arranged four times more densely than in the first area 30. The smaller receiving positions are intended for vessels with a smaller volume.

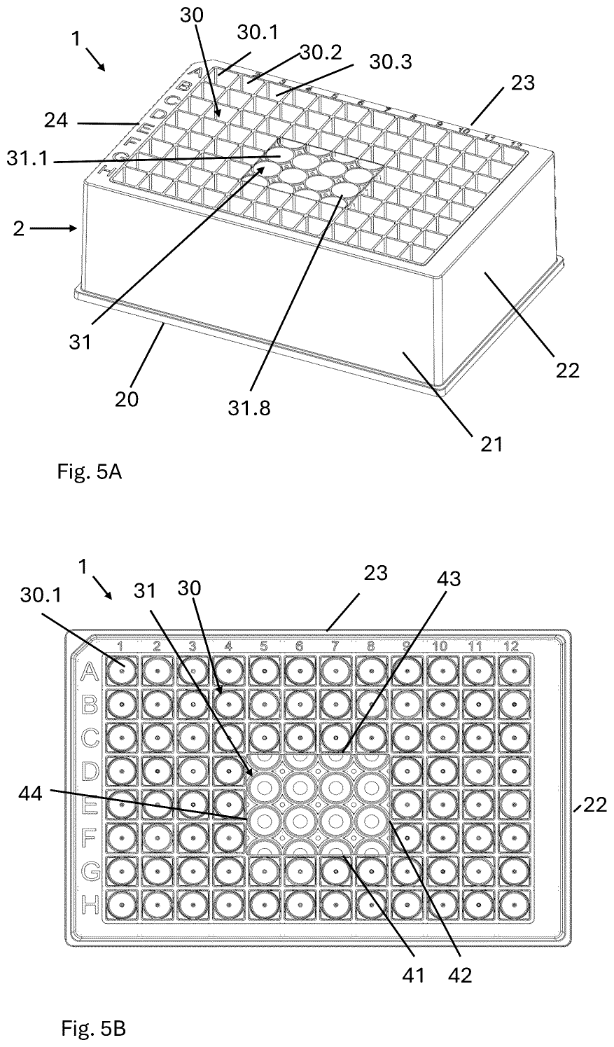

FIGS. 5A and 5B show a fifth embodiment of a container 1 according to the invention for holding sample vessels (wells) and/or pipette tips according to the present invention. In contrast to the previous embodiments, the container 1 has a second area 31, which is rectangular in shape and occupies an area in the middle of the container 1, i.e. surrounded by the first area 30.

The part with the second area 31 may be designed as a module and inserted into a corresponding recess in the part comprising the first area 30. Accordingly, there are four separating planes or separating seams 41, 42, 43, 44 aligned perpendicular/parallel to each other, which are arranged between the second area 31 and the first area 30.

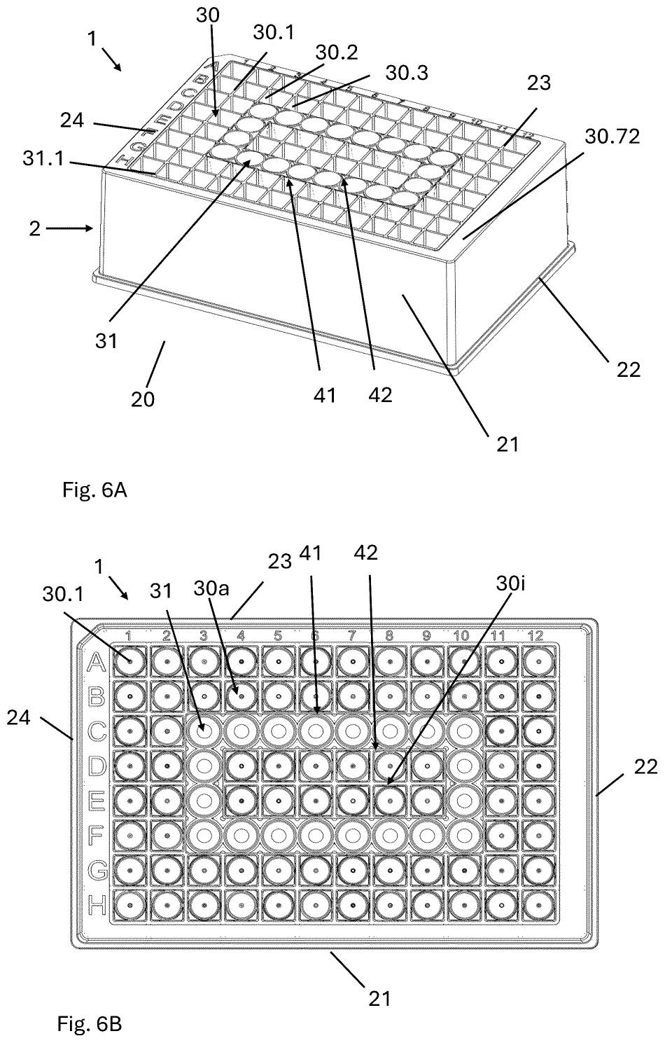

FIGS. 6A and 6B show a sixth embodiment of a container 1 according to the present invention for holding sample vessels (wells) and/or pipette tips. In contrast to the fifth embodiment, a second area 31 is provided which separates the first area 30 into an inner area 30i and an outer area 30a, i.e. the second area 31 is arranged between the inner and outer areas 30i, 30a. Accordingly, an outer separating seam 41 (rectangular in plan view) and an inner separating seam 42 (rectangular in plan view) are provided between the areas 30a, 31 and 31, 30i, respectively.

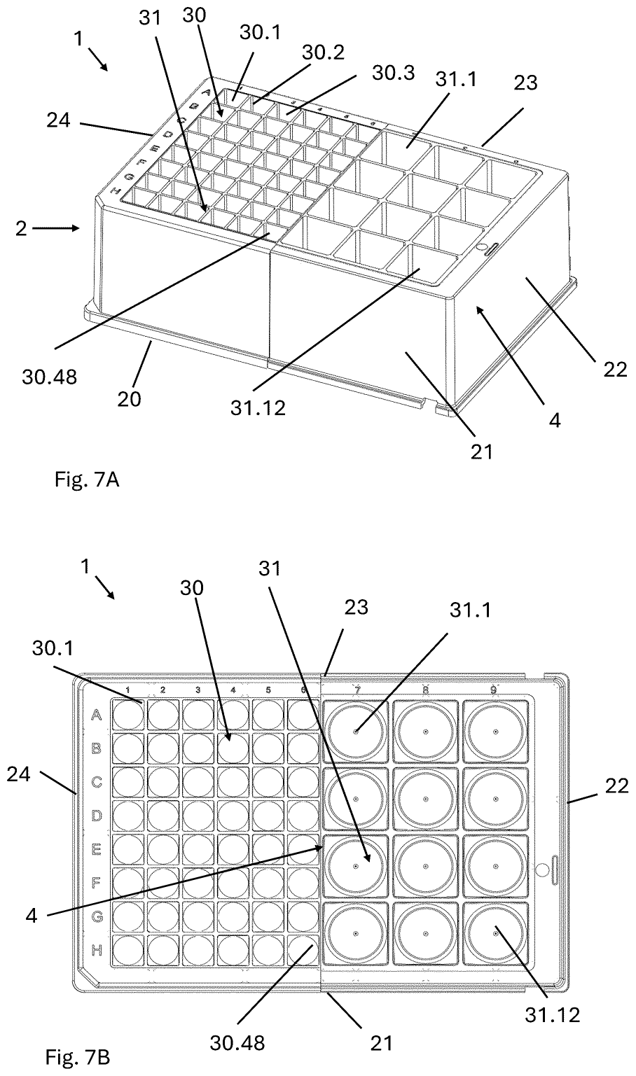

FIGS. 7A and 7B show a seventh embodiment of a container 1 according to the present invention for holding sample vessels (wells) and/or pipette tips. This embodiment corresponds substantially to the second embodiment, with the difference that in the seventh embodiment only 12 (instead of 48) (4-fold) larger receiving positions are provided in the second area.

A number of analysis methods require liquid transfer between vessels of different volumes. This kind of liquid transfer is accomplished by providing a configuration corresponding to or similar to the seventh embodiment, in which a certain proportion x1 of the total area of the holding component 3 is provided for receiving positions of type/size X1, a further proportion x2 for receiving positions of type/size X2, etc.

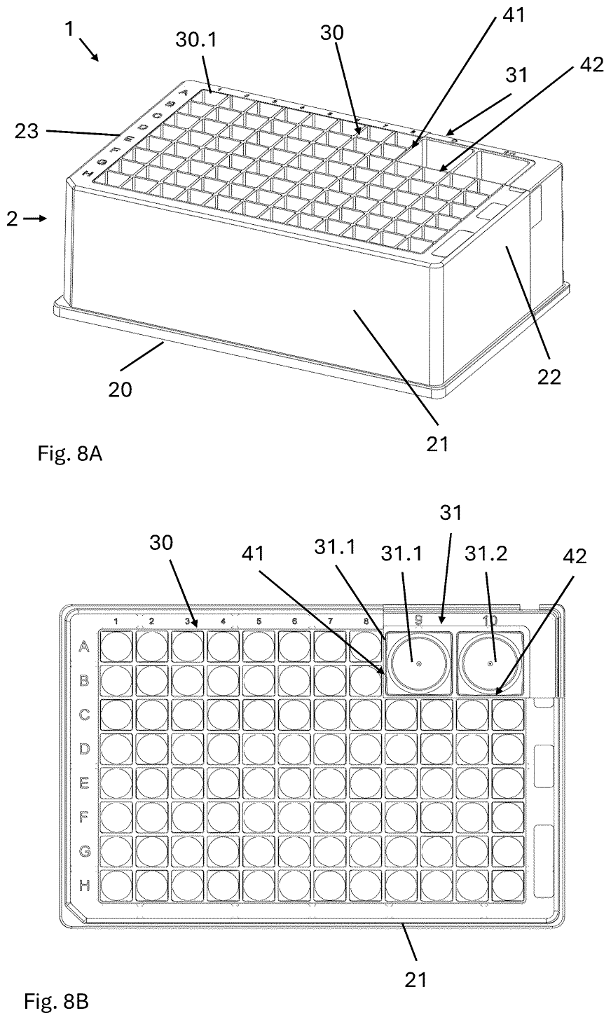

FIGS. 8A and 8B show an eighth embodiment of a container 1 according to the present invention for receiving sample vessels (wells) and/or pipette tips. This embodiment corresponds substantially to the fourth embodiment, with the difference that in the eighth embodiment, in the second area 31, only two (2) (instead of 48) (4-fold) larger receptacles are provided.

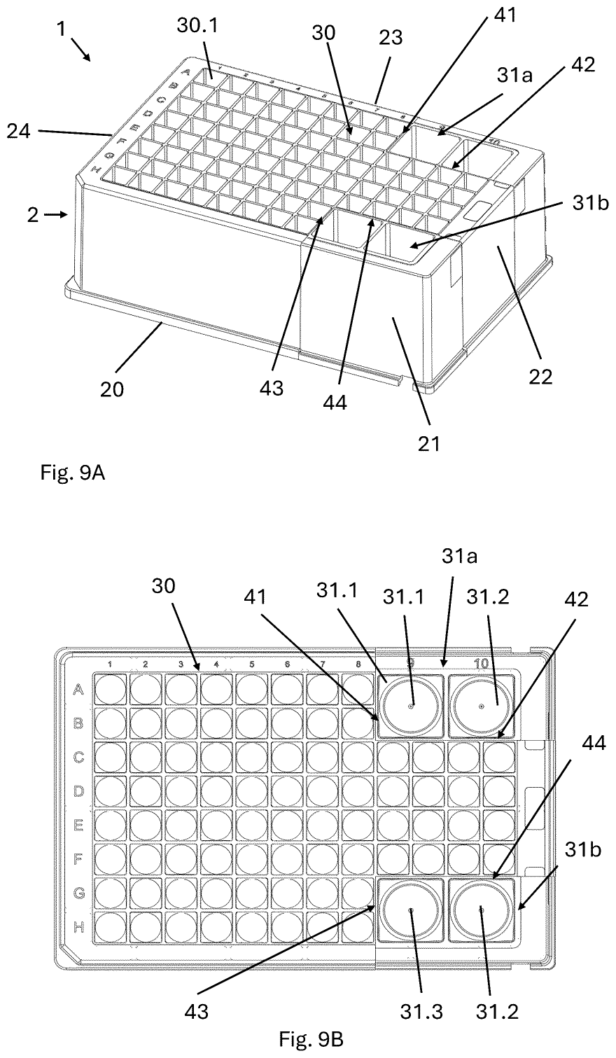

FIGS. 9A and 9B show a ninth embodiment of a container 1 according to the invention for holding sample vessels (wells) and/or pipette tips according to the present invention. This embodiment corresponds substantially to the eighth embodiment, with the difference that in the ninth embodiment two (2) second areas 31a and 31b are provided corresponding to the one second area 31 of the eighth embodiment. The areas each have two receptacles 31.1, 31.2 and 31.3, 31.4, which are arranged in the corners of the container between the first wall 21 and the second wall 22 and between the second wall 22 and the third wall 23.

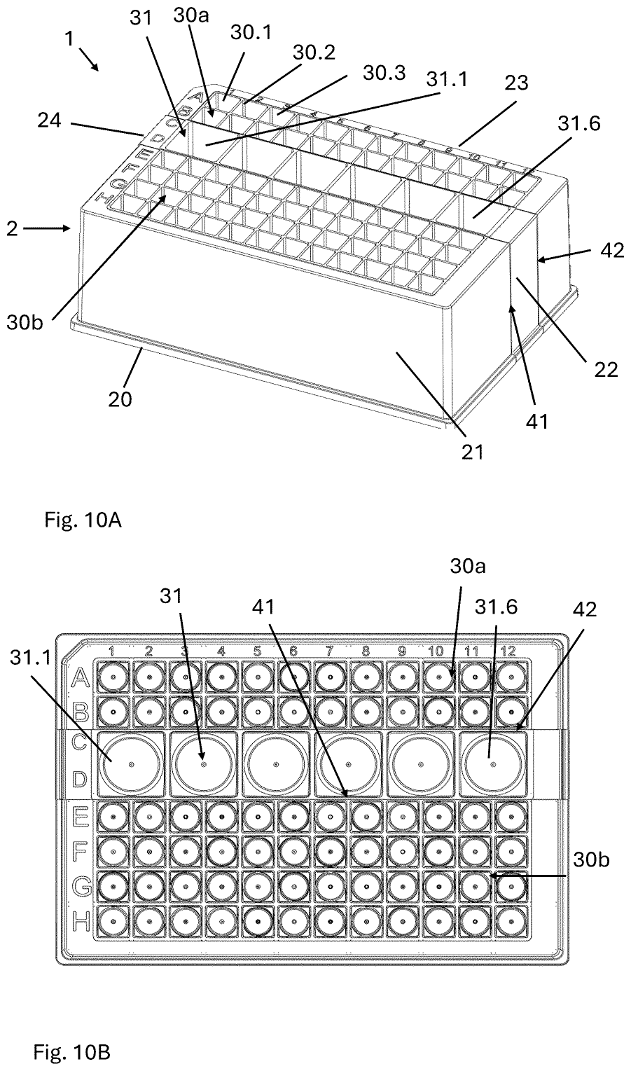

FIGS. 10A and 10B show a tenth embodiment of a container 1 according to the present invention for holding sample vessels (wells) and/or pipette tips. This embodiment corresponds substantially to the eighth embodiment, with the difference that in the tenth embodiment a second area 31 with six (6) (4-fold) larger receptacles 31.1, . . . , 31.6 arranged in a row is provided. This row 31 interrupts the first area 30 and divides it into two first areas 30a and 30b.

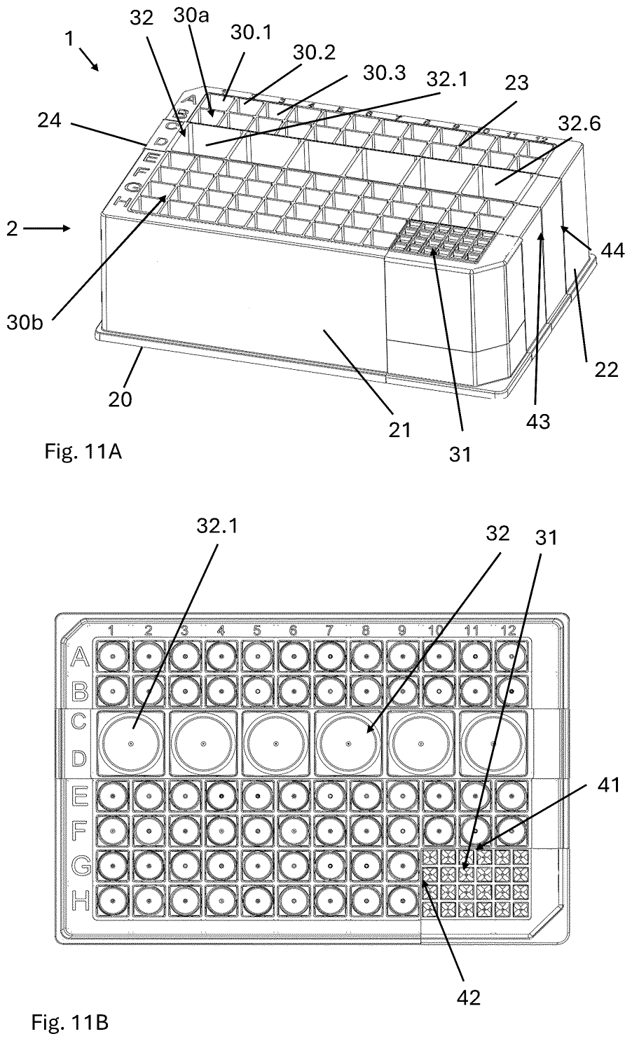

FIGS. 11A and 11B show an eleventh embodiment of a container 1 according to the present invention for holding sample vessels (wells) and/or pipette tips. This embodiment is a combination of the fourth and tenth embodiments, wherein a second area 31 according to the fourth embodiment and a third area 32 corresponding to the second area 31 of the tenth embodiment are provided.

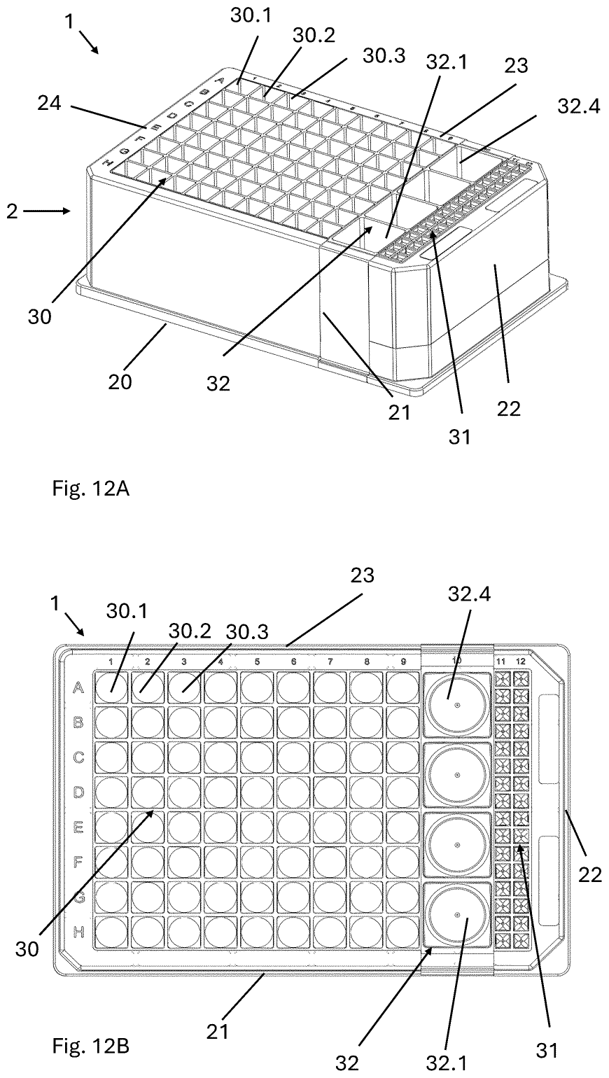

FIGS. 12A and 12B show a twelfth embodiment of a container 1 according to the invention for holding sample vessels (wells) and/or pipette tips according to the present invention. This embodiment corresponds substantially to the eleventh embodiment. However, in contrast to the eleventh embodiment, the second area 31 and the third area 32 are each arranged as a row which is transverse to a longitudinal axis of the container 1. The second area 31 and the third area 32 are adjacent to each other. The third area 32 is also adjacent to the first area 30.

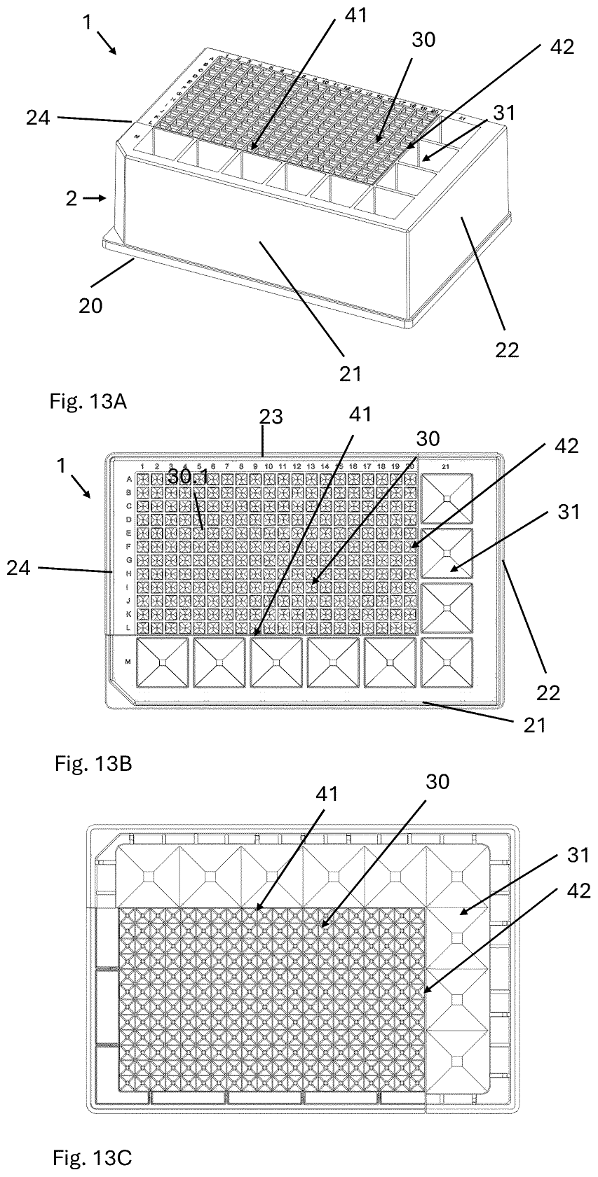

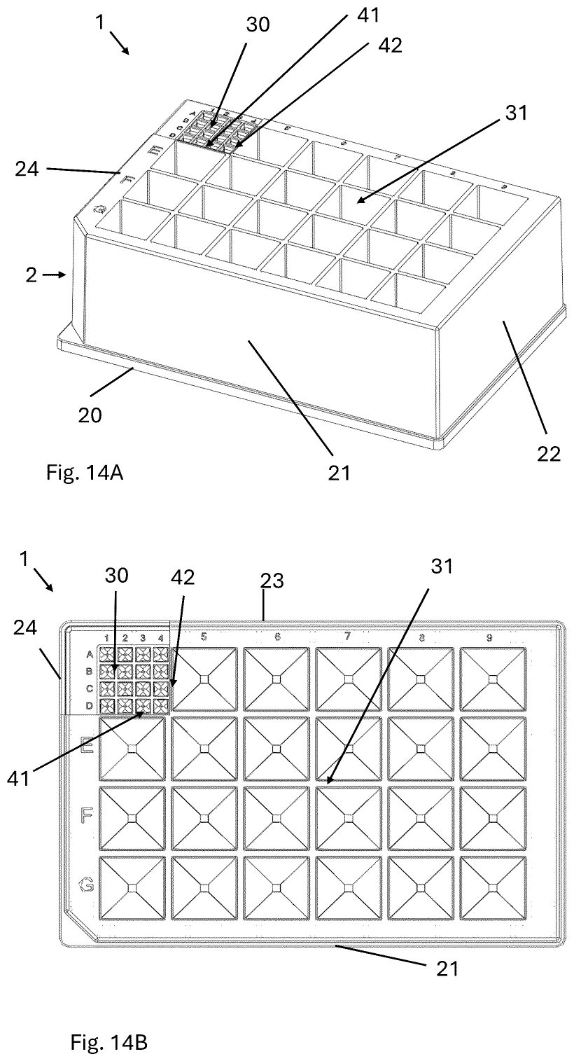

FIGS. 13A, 13B and 13C show a thirteenth embodiment of a container 1 according to the present invention for holding sample vessels (wells) and/or pipette tips. This embodiment corresponds substantially to the first embodiment. However, in contrast to the first embodiment, the second area 31 is arranged in an L-shape along two edges (along walls 21 and 22). The second area 31 has receptacles, one of which has 16 times the area of a receptacle in the first area 30. The bases of the areas 30, 31 may be closed or open, depending on the application and intended use, see FIG. 13C.

FIGS. 14A and 14B show a fourteenth embodiment of a container 1 according to the present invention for holding sample vessels (wells) and/or pipette tips. This embodiment corresponds substantially to the eighth embodiment. However, in contrast to the eighth embodiment, the first area 30 occupies a significantly smaller part of the surface of the holding component 3 than the second area, whereby the number of the 16 receiving positions in the first area 30 is as large as the area of one receiving positions in the second area 31.

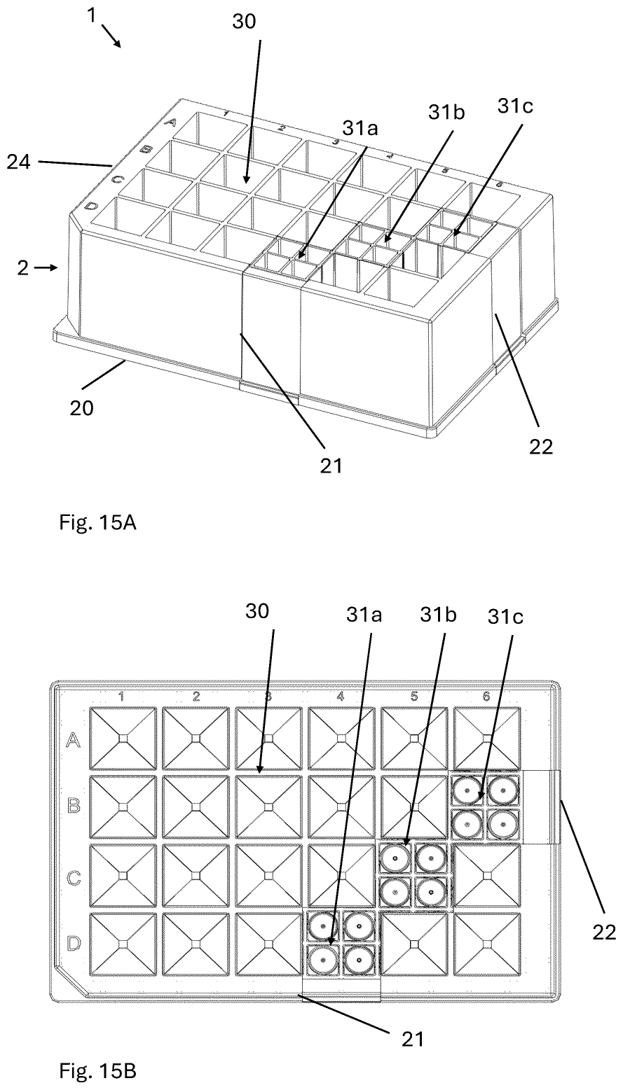

FIGS. 15A and 15B show a fifteenth embodiment of a container 1 according to the present invention for holding sample vessels (wells) and/or pipette tips This embodiment corresponds substantially to previous embodiments. However, in this embodiment the second area 31 consists of three sub-areas 31a, 31b, 31c, each with four (4) receiving positions. The sub-areas 31a, 31b, 31c of the second holding area 31 each have four (4) receiving positions, each of which is the same size as one receiving position of the first area 30. The second receiving positions divide the first holding area 30 into three and 18 receiving positions, respectively, on a first side and on a second side of a diagonal line.

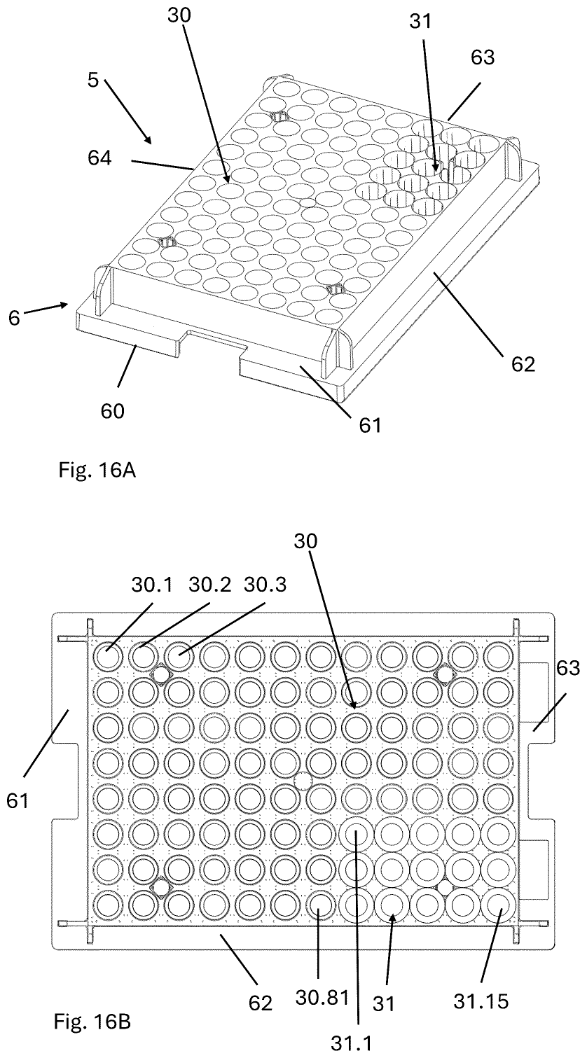

FIGS. 16A and 16B show a first embodiment of a tray 5 according to the present invention for holding sample vessels (wells) and/or pipette tips.

The tray 5 has a carrier component 6 with four side elements 61, 62, 63, 64 and a support surface 60. The support surface 60 may rest on a container component (not shown) so that the tray 5 together with a container component forms a modular container 1 according to the previous embodiments.

In addition, the tray 5 has a holding component 3 with a first area 30 with a plurality (81) of first receiving positions 30.1, 30.2, 30.3, . . . 30.81 for a first type of sample vessels and/or pipette tips, and a second area 31 with a plurality (15) of second receiving positions 31.1, 31.2, 31.3, . . . 31.15 for a second type of sample vessels and/or pipette tips, as described in connection with the containers 1 according to the invention.

For example, the first receiving positions/locations 30.1, . . . 30.81 may be suitable for receiving vessels corresponding to a microtiter plate. The vessels may be individual and inserted into different first receiving positions, or they may be segmented, i.e. the vessels may be connected as strips or as a two-dimensional flat element, e.g. as an element with 2×2=4 vessels. The holding component 3 and the vessels may be made of different materials. The vessels may be of the same or different shapes and/or sizes and/or made of the same or different materials. It is possible that the vessels are permanently connected to the receiving positions or they may be formed in one piece (integrally) with the tray 5.

For example, the second receiving positions 31.1, . . . , 31.15 may be suitable for holding pipette tips. The pipette tips are usually provided individually and may be inserted into different second receiving positions. The holder component 3 and the pipette tips may be made of different materials. The pipette tips may each have the same or different shapes and/or sizes and/or be made of the same or different materials.

The tray 5 may be equipped with vessels and/or pipette tips that are required in a specific analysis program, which may be carried out, for example, in an analysis robot. The vessels are placed at specific receiving locations in the first area 30 and, if necessary, filled with reagents required in the analysis program. The pipette tips are placed at specific receiving locations in the second area. They are used to transport liquids through the analysis robot as part of the analysis program. The pipette tips allow liquids to be transported between the vessels.

A kit including the tray according to the invention is multifunctional because it combines a microtiter plate with sample wells in a first receptacle area 30 and with pipette tips in a second receptacle area 31.

Some of the receiving positions are therefore intended for vessels, while others are intended for pipette tips. The vessels may be integrated in the tray 5, for example at receiving positions of the first area 30. Depending on the analysis program, the vessels and pipette tips may have different geometries, different volumes, different materials, etc., and may be filled with specific reagents. Such a kit may then be loaded with a sample to be analyzed (e.g. blood) and inserted into a small analysis device. An analysis program is then started.

In the following embodiments, corresponding features are designated with the same reference numerals as in FIGS. 16A and 16B.

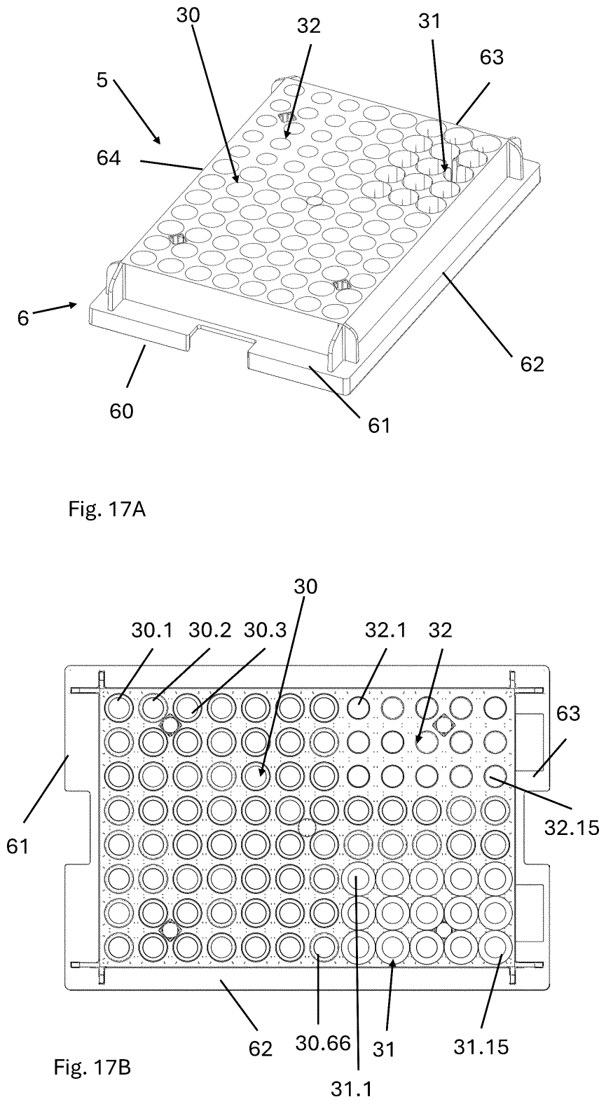

FIGS. 17A and 17B show a second embodiment of a tray 5 according to the present invention for holding sample vessels (wells) and/or pipette tips. In contrast to the previous embodiment, the tray 5 has a holding component 3 with a first area 30 with a plurality (66) of first receiving positions for a first type of sample vessels and/or pipette tips, a second area 31 with a plurality (15) of second receiving positions for a second type of sample vessels and/or pipette tips, and a third area 32 with a plurality (15) of third receiving positions for a third type of sample vessels and/or pipette tips.

The second area 31 and the third area 32 are each arranged as 3×5 arrays of receiving positions in corners of the holding component 3.

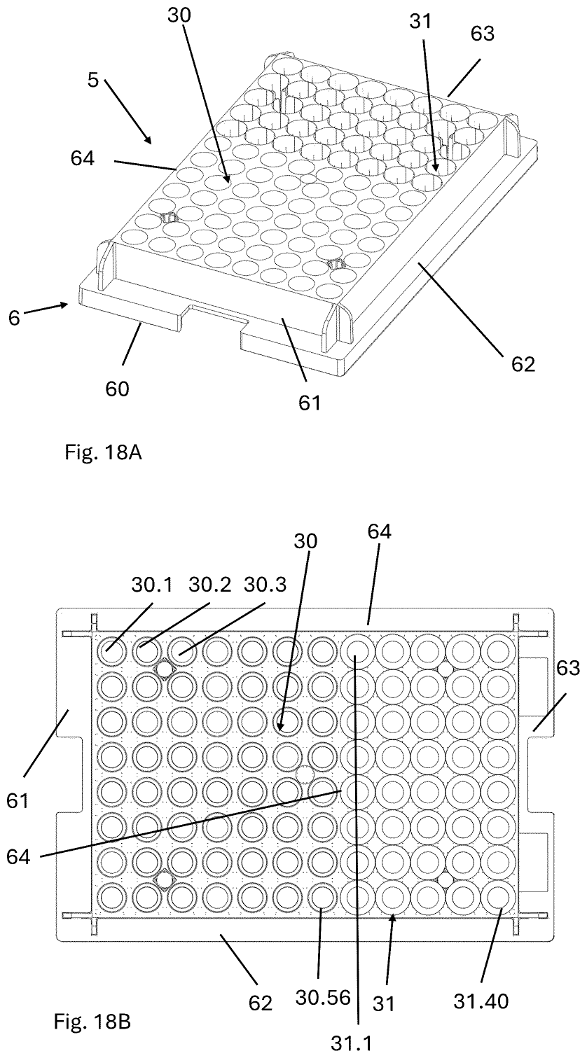

FIGS. 18A and 18B show a third embodiment of a tray 5 according to the present invention for receiving sample vessels (wells) and/or pipette tips. In contrast to the first embodiment of a tray according to FIGS. 16A and 16B, the tray 5 has a holding component 3 with a first area 30 with a plurality (56) of first receiving positions for a first type of sample vessels and/or pipette tips, and a second area 31 with a plurality (40) of second receiving positions for a second type of sample containers and/or pipette tips. The areas 30 and 31 are each located on one side of the holding component 3. They are separated by a (virtual or real) separating plane 4.

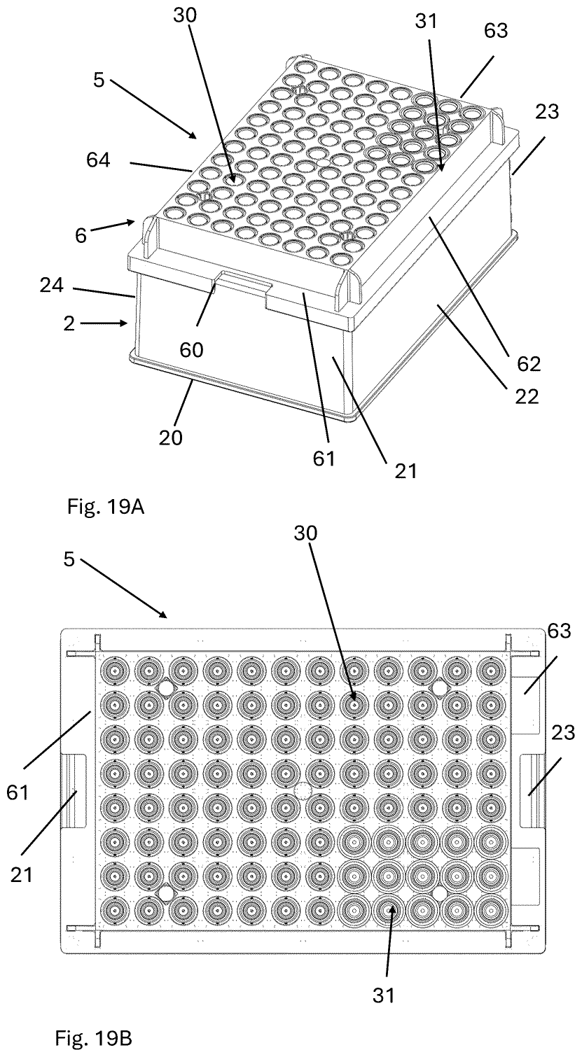

FIGS. 19A and 19B show a first embodiment of a combination according to the invention of a housing and a tray 5, as described above, for receiving sample vessels (wells) and/or pipette tips according to the present invention.

The housing has, similar to the containers 1 described above, a housing component 2 with four approximately vertically aligned wall elements 21, 22, 23, 24 and a base 20. The housing also has a central upper opening over which the tray 5 is placed. The housing may optionally have a holding component as described in connection with the containers 1 according to the invention instead of the central opening.

The tray 5 may essentially be constructed like the tray 5 of the first embodiment (FIGS. 16A, 16B).

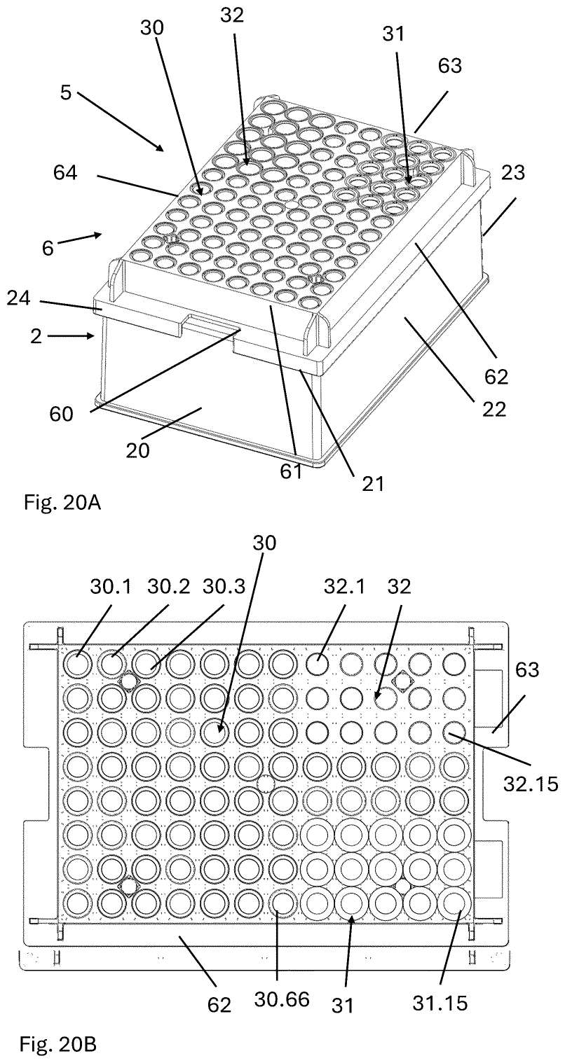

FIGS. 20A and 20B show a second embodiment of a combination of a housing and a tray 5 according to the present invention, as described above, for holding sample vessels (wells) and/or pipette tips. In contrast to the previous embodiment, the tray 5 is constructed as shown and described in FIGS. 17A and 17B.

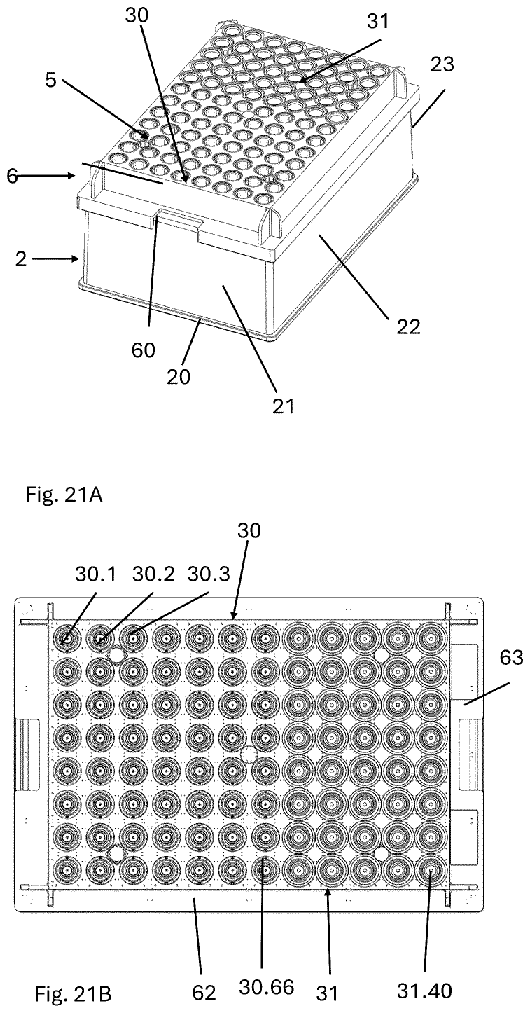

FIGS. 21A and 21B show a third embodiment of a combination according to the invention comprising a housing and a tray 5 as described above for receiving sample vessels (wells) and/or pipette tips according to the present invention. In contrast to the previous embodiment, the tray 5 is constructed as shown and described in FIGS. 18A and 18B.

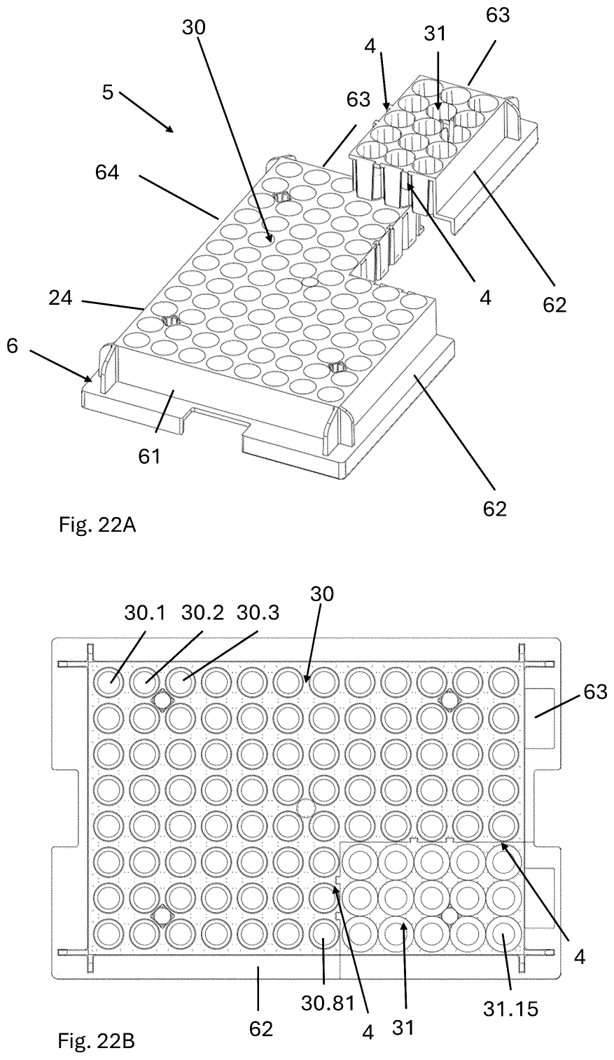

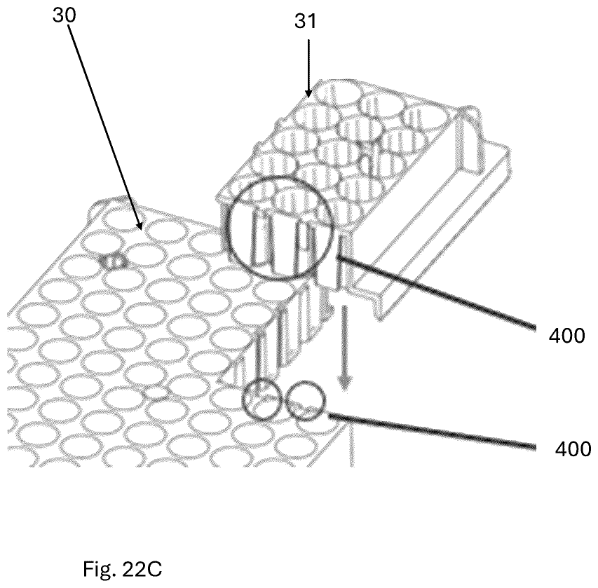

FIGS. 22A and 22B show an embodiment of a modular tray 5 according to the present invention for holding sample vessels (wells) and/or pipette tips. In this embodiment, two areas 30, 31 are provided for holding sample vessels (wells) and/or pipette tips. In FIG. 22A, the modules 30, 31 of the tray 5 are shown separately from each other, while in FIG. 22B, the tray 5 is shown assembled.

The interruption planes 4 between the modules 30 and 31 may be provided with guide and/or fastening elements by means of which the modules may be specifically assembled or fixed to one another. In this way, different variants may be connected to one another. For this purpose, elements for locking, clipping, dovetail guides, guiding elements, locking nubs, etc. may be provided in the area of the interruption planes 4 (i.e. usually on the sides) of the individual modules 30, 31. In this embodiment, a dovetail guide 400 has been used as an example, as may be seen from the enlarged view of a detail in FIG. 22C.

The principle of modular subdivision and combinability may be transferred to other arrangements of different areas 30, 31, 32 of trays 5 and containers 1 according to the invention as described above.

Each of the containers 1 and each of the trays 5 according to the invention may be designed as a single piece or, for example, in the modular form described, i.e. assembled/composed of several parts. Thus, a first module may comprise a first receiving area 30, a second module may comprise second receiving area 31, etc. The modules are joined together along one or more interruption planes 4. This allows different modules to be combined depending on the intended use.

The materials of the individual modules 30, 31, 32 may be the same or different, depending on the intended use as a sample vessel holder or pipette tip holder.

All receptacle positions may have a support edge that limits a receptacle opening for the support of a corresponding projection or web that is designed on the outside of a vessel or pipette tip to be compatible with a specific type/size of receptacle position. The opening may be limited by a sleeve with a specific axial length.

By selecting a suitable arrangement of receptacles of different types or sizes, programmed analysis procedures in an analysis robot, for example, may be optimized in terms of time and reliability of the procedure by shortening the distances involved in handling pipette tips and sample vessels.

1. A device holding at least one of sample vessels and pipette tips, comprising:
a holding component with at least one first receiving position and at least one second receiving position, wherein each of the first receiving position and the second receiving position are configured for receiving one of a sample vessel and a pipette tip;
wherein the at least first receiving position and the at least one second receiving position have different configuration.

2. The device for holding at least one of sample vessels and pipette tips according to claim 1, wherein the at least first receiving position and the at least second receiving position are designed for receiving different vessels and/or different pipette tips, and/or at least one receiving position for receiving a sample vessel and at least one receiving position for receiving a pipette tip.

3. The device for holding at least one of sample vessels and pipette tips according to claim 1, wherein the holding component (has a plate-like holding plane, and the holding positions are designed as openings in the holding component.

4. The device for holding at least one of sample vessels and pipette tips according to claim 3, wherein the opening of the first holding position has a different diameter than the opening of the second holding position.

5. The device for holding at least one of sample vessels and pipette tips according to claim 3, wherein the first receiving position and the second receiving position each have an edge region which delimits the respective opening, wherein the edge region of the first receiving position and the edge region of the second receiving position have a design different from each other.

6. The device for holding at least one of sample vessels and pipette tips according to claim 1, wherein the holding component has an arrangement of at least one first area with at least a first receiving position and at least a second area with at least a second receiving position.

7. The device for holding at least one of sample vessels and pipette tips according to claim 6, wherein the areas form integral modular areas.

8. The device for holding at least one of sample vessels and pipette tips according to claim 6, wherein the holding component essentially consists of areas arranged adjacent to one another, or the areas are designed as individual modules.

9. The device for holding at least one of sample vessels and pipette tips according to claim 8, wherein the modularly designed areas may be joined together and/or fastened to one another.

10. The device for holding at least one of sample vessels and pipette tips according to claim 9, wherein the modularly designed areas have guide and/or fastening elements.

11. The device for holding at least one of sample vessels and pipette tips according to claim 1, wherein the device is designed as a container comprising a housing component and the holding component arranged thereon.

12. The device for holding at least one of sample vessels and pipette tips according to claim 1, wherein the device is designed as a tray.

13. A combination of a device according to claim 12 and a housing component, wherein the tray is arranged on the housing component.

14. A kit comprising:
a device according to claim 1; and
at least one of sample vessels and/or pipette tips for use in a predetermined analysis program.
